(19) United States
(12) Patent Application Publication
(10) Pub. No.: US 2026/0347518 A1
(43) Pub. Date: Nov. 5, 2026

(54) PROCESS FOR THE POLYMERIZATION OF OLEFINS

(71) Applicant: Basell Poliolefine Italia S.r.l., Milano (IT)

(72) Inventors: Mara Destro, Ferrara (IT); Diego Brita, Ferrara (IT); Fabrizio Piemontesi, Ferrara (IT); Fabio Testoni, Ferrara (IT); Stefano Sessa, Ferrara (IT); Lelio Basile, Ferrara (IT); Alberto Nardin, Ferrara (IT); Tiziana Caputo, Ferrara (IT)

(73) Assignee: Basell Poliolefine Italia S.r.l., Milano (IT)

(21) Appl. No.: 19/486,280

(22) PCT Filed: May 31, 2024
(86) PCT No.: PCT/EP2024/065010

§ 371 Date: Nov. 20, 2025

(30) Foreign Application Priority Data
May 31, 2023 (EP) 23176252.7

(51) Int. Cl. C08F 110/06; C08F 2/34; C08F 4/642; C08F 4/646; C08F 210/16; C08K 5/103

(52) U.S. Cl. CPC C08F 110/06; C08F 2/34; C08F 4/642; C08F 4/6465; C08F 210/16; C08K 5/103

(57) ABSTRACT

A process for the preparation of polyolefins is carried out in the presence of (i) a Ziegler-Natta catalyst, (ii) an aluminum alkyl cocatalyst, optionally (iii) an external donor, and at least 50 ppm of a compound selected from mono or diglycerol ester derivatives of monocarboxylic acids, based on the amount of polyolefin produced.

### FIELD OF THE DISCLOSURE

In general, the present disclosure relates to the field of chemistry. More specifically, the present disclosure relates to polymer chemistry. In particular, the present disclosure relates to a process for preparing polyolefins.

### BACKGROUND OF THE DISCLOSURE

Polymerization process aids (PPAs) are used in processes for the polymerization of olefins to reduce or eliminate wall sheeting and formation of polymer agglomerates in the polymerization reactor or in downstream equipment. In some instances, the downstream equipment includes degassing and recovery vessels. In the context of olefin polymerization and depending upon the specific functions, PPAs include antifouling agents, antistatic agents, activity inhibitors, productivity inhibitors or kinetic modifiers. In some instances, PPAs are made from or containing compounds having polar functional groups. In some instances, the polar functional groups are acid or ester groups, amine or amide groups or hydroxyl or ether groups. In some instances, PPAs are selected from the group consisting of polysulfone copolymers, polymeric polyamines, polyalcohols, hydroxyesters of polyalcohols, salts of alkylarylsulfonic acids, polysiloxanes, alkoxyamines, and polyglycol ethers.

It is believed that depending on the molecular structure, reaction conditions and reactor type, the effectiveness of PPAs changes in some instances. In some instances, the type of polyolefin plays a role. In some instances, propylene/ethylene rubbery copolymers tend to adhere to reactor walls and create fouling. In some instances, the problem is more evident for propylene-ethylene copolymer particles with small size (less than 500 μm) and high ethylene content.

### SUMMARY OF THE DISCLOSURE

In a general embodiment, the present disclosure provides a process for the preparation of polyolefins, carried out in the presence of (i) a Ziegler-Natta catalyst, (ii) an aluminum alkyl cocatalyst, optionally (iii) an external donor, and (iv) at least 50 ppm of a compound made from or containing mono or diglycerol ester derivatives of saturated C₆-C₁₂, based on the amount of polyolefin produced. In some embodiments, compound (iv) is a polymerization process aid (PPA). In some embodiments, compound (iv) is made from or containing mono or diglycerol ester derivatives of saturated C₆-C₁₀ monocarboxylic acids.

### BRIEF DESCRIPTION OF THE DRAWINGS

FIG. 1 shows a schematic of a gas phase polymerization reactor having two interconnected polymerization zones.

### DETAILED DESCRIPTION OF THE DISCLOSURE

In some embodiments, the PPA is made from or containing (a) more than 50% wt, alternatively more than 55% wt, alternatively in the range of 60-90% wt, of mono or diglycerol ester derivatives of saturated C₆-C₁₀, alternatively C₈-C₁₀, monocarboxylic acids, and (b) mono or polyglycerol fatty acid esters, with respect to the total amount of mono or polyglycerol fatty acid esters.

In some embodiments, the PPA is made from or containing one or more of mono or diglycerol ester derivatives of saturated C₆-C₁₀, alternatively C₈-C₁₀, monocarboxylic acids and mixtures thereof. In some embodiments, the PPA is made from or containing (a) more than 50% wt, alternatively more than 55% wt, alternatively in the range of 60-90% wt, of mono or diglycerol ester derivatives of saturated C₆-C₁₀, alternatively C₈-C₁₀, monocarboxylic acids selected from the group consisting of glycerol monoester or diester of octanoic acid, glycerol monoester or diester of decanoic acid, glycerol diester mixed octanoic and decanoic acid, diglycerol mono, di- or triester of octanoic acid, diglycerol mono, di- or triester of decanoic acid, diglycerol di or triester of mixed octanoic and decanoic acid and mixtures thereof, and (b) mono or polyglycerol fatty acid esters, with respect to the total amount of mono or polyglycerol fatty acid esters.

In some embodiments, PPA comprises is made from or containing (a) more than 50% wt, alternatively more than 55% wt, alternatively in the range of 60-90% wt, of mono or diglycerol ester derivatives of saturated C₆-C₁₀, alternatively C₈-C₁₀, monocarboxylic acids selected from the group consisting of glycerol mono octanoate; mixtures made from or containing glycerol diester of octanoic acid, glycerol diester of mixed octanoic and decanoic acid; and diglycerol mono ester of octanoic acid, diglycerol mono ester of decanoic acid, and mixtures thereof, and (b) mono or polyglycerol fatty acid esters, with respect to the total amount of mono or polyglycerol fatty acid esters.

In some embodiments, the mono or diglycerol ester derivatives of saturated C₆-C₁₂, alternatively C₈-C₁₀, monocarboxylic is obtained by extraction from, treatment of, or both natural sources. In some embodiments, the process for obtaining the ester derivatives includes glycerolysis of edible oils into diglycerides. In some embodiments, the edible oils are commercially available. In some embodiments, the edible oils are commercially available in pure form or mixtures. In some embodiments, minor amounts of other components remain in the mixture. In some embodiments, the other components are non-esterified mono or polyglycerol. In some embodiments, pure glycerol esters are synthesized via an esterification reaction as described in Chinese Patent No. CN107935851B. In some embodiments, the glycerol ester is glycerol caprylate.

In some embodiments, the mono or diglycerol esters are commercially available with different purity. In some embodiments, glycerol monoester of decanoic acid and glycerol monoester of octanoic acid are commercially available from SigmaAldrich. In some embodiments, glycerol diester mixed octanoic and decanoic acid is commercially available from Dayang Chem. In some embodiments, diglycerol esters of octanoic acid and decanoic acid are commercially available from Ality Chemical Corporation.

In some embodiments, PPAs are used as such or with the aid of a dispersing medium. In some embodiments, the dispersing medium is selected from liquid non-aqueous solvents, alternatively from liquid hydrocarbons.

In some embodiments, the PPA is liquid at room temperature.

In some embodiments, the amount of PPA introduced into the polymerization reactor is from 70 to 2000 ppm per weight, alternatively from 150 to 1500 ppm per weight, alternatively from 200 to 1000 ppm per weight, referring to the weight of the prepared polyolefin.

In some embodiments, PPA is fed to the polymerization reactor in a flow of saturated or unsaturated hydrocarbons, having from 2 to 6 carbon atoms, or a mixture of saturated and unsaturated hydrocarbons. In some embodiments, the hydrocarbon is a monomer or an alkane. In some embodiments, the monomer is propylene. In some embodiments, the alkane is propane. In some embodiments, the monomer, the alkane, or both are in liquid or gas form. In some embodiments, the PPA is diluted and homogenized with a solvent at short distance from the injection point by mixing/homogenizing/dispersing systems, thereby increasing the volume and rendering the injection smoother and more reliable. In some embodiments, the mixing/homogenizing/dispersing systems are static mixers.

In some embodiments, the PPA is introduced into the reactor in a variety of ways. In some embodiments, the PPA is fed directly into the reactor, into a line leading to the reactor, into a line exiting the reactor, or a combination thereof. In some embodiments, PPA is fed:
upstream or into a catalyst precontacting vessel, that is, a vessel in which the catalyst components are brought into contact with each other;
upstream or into a prepolymerization reactor;
at any other point upstream a polymerization reactor;
in case of a cascade process with one or more liquid or gas phase reactors, at any point in-between two reactors;
distributed into a reactor or in a recirculation flow thereof;
in the polymer discharge out of a polymerization reactor; or.
in the unreacted monomer separation and finishing sections downstream the polymerization reactor(s).
   In some embodiments, the PPA is distributed into a reactor or in a recirculation flow thereof, by feeding into the bed of a fluidized bed gas phase reactor, into the bed of a fast fluidization bed of a riser of a multizone circulating reactor, into a packed bed of a downcomer of a multizone circulating reactor, or a combination thereof.

In some embodiments, the present disclosure provides a process for the polymerization of olefins. In some embodiments, the olefins are 1-olefins, that is, hydrocarbons having terminal double bonds, without being restricted thereto. In some embodiments, the 1-olefins are selected from the group consisting of linear or branched 1-alkenes having from 2 to 12 carbon atoms, conjugated and non-conjugated dienes, and vinyl-aromatic compounds. In some embodiments, the linear 1-alkenes have from 2 to 10 carbon atoms. In some embodiments, the linear 1-alkenes are selected from the group consisting of ethylene, propylene, 1-butene, 1-pentene, 1-hexene, 1-heptene, 1-octene, and 1-decene. In some embodiments, the branched 1-alkenes have from 2 to 10 carbon atoms. In some embodiments, the branched 1-alkene is 4-methyl-1-pentene. In some embodiments, the dienes are selected from the group consisting of 1,3-butadiene, 1,4-hexadiene, and 1,7-octadiene. In some embodiments, the vinyl-aromatic compounds are styrene or substituted styrene. In some embodiments, mixtures of various 1-olefins are polymerized. In some embodiments, the olefins have the double bond as part of a cyclic structure. In some embodiments, the cyclic structure has one or more ring systems. In some embodiments, the olefins, including a cyclic structure, are selected from the group consisting of cyclopentene, norbornene, tetracyclododecene, methylnorbornene, 5-ethylidene-2-norbornene, norbornadiene, and ethylnorbornadiene. In some embodiments, mixtures of two or more olefins are polymerized.

In some embodiments, the process is for the homopolymerization or copolymerization of ethylene or for the homopolymerization or copolymerization of propylene. In some embodiments, the process is for the homopolymerization, copolymerization, or both of propylene.

In some embodiments, comonomers for use in ethylene polymerization are 1-alkenes having from 3 to 8 carbon atoms. In some embodiments, the 1-alkenes are selected from the group consisting of 1-butene, 1-pentene, 1-hexene and 1-octene. In some embodiments, the 1-alkenes are in amount of up to 20 wt. %, alternatively from 0.01 wt. % to 15 wt. %, alternatively from 0.05 wt. % to 12 wt. %, based on the total weight of the final polymer. In some embodiments, comonomers for use in propylene polymerization are selected from the group consisting of ethylene, 1-butene, and 1-hexene. In some embodiments, the comonomers are in amount of up to 40 wt. %, alternatively from 0.5 wt. % to 35 wt. %, based on the total weight of the final polymer.

In some embodiments, the propylene/ethylene copolymer is made from or containing from 15 to 80% of ethylene, alternatively from 20 to 70% wt.

In some embodiments, the present disclosure provides a process for preparing various types of olefin polymers. In some embodiments, the prepared olefin polymers are broad molecular weight olefin polymers. In some embodiments, the prepared olefin polymers are multimodal olefin polymers. As used herein, the term “multimodal” refers to the modality of the molecular weight distribution and includes bimodal. In some embodiments, the polymers are obtained from polymerizing olefins in a cascade of two or more polymerization reactors or in different zones of a multizone reactor under different reaction conditions. The “modality” indicates how many different polymerization conditions were utilized to prepare the polyolefin, independently whether this modality of the molecular weight distribution is recognizable as separated maxima in a gel permeation chromatography (GPC) curve. In some embodiments, the olefin polymer has a comonomer distribution.

In some embodiments, the polymerization of olefins is carried out using titanium-based Ziegler-Natta-catalysts.

In some embodiments, the Ziegler-Natta catalysts are made from or containing:
(i) a solid catalyst component made from or containing Mg, Ti, a halogen and optionally an electron donor compound (internal donor),
(ii) an alkylaluminum compound, and
(iii) optionally, an electron-donor compound (external donor).

In some embodiments and during the homopolymerization or copolymerization of propylene, an internal donor in catalyst component (i) is present.

In some embodiments, the solid catalyst component (i) is prepared by one or more steps (a) carried out at a temperature ranging from 0 to 150 °C, wherein a Mg based compound of formula (MgClₘX₂₋ₘ)·nLB, where m ranges from 0 to 2, n ranges from 0 to 6, X is, independently, halogen, R¹, OR¹, —OCOR¹ or O—C(O)—OR¹ group, wherein R¹ is a C₁-C₂₀ hydrocarbon group, and LB is a Lewis base, is reacted with a liquid medium made from or containing a Ti compound, having at least a Ti—Cl bond, in an amount such that the Ti/Mg molar ratio is greater than 3.

In some embodiments, the liquid medium is made from or containing a titanium compound of formula Ti(OR¹)_{q-y}Cl_{y}, where q is the valence of titanium, y is a number between 1 and q and R¹ is a C₁-C₂₀ hydrocarbon group.

In some embodiments, the titanium compounds are titanium polyhalogenated compounds. In some embodiments, the titanium polyhalogenated compounds are titanium tetrahalides or halogenalcoholates. In some embodiments, the titanium compounds are selected from the group consisting of TiCl₄ and Ti(OEt)Cl₃.

In some embodiments, the liquid medium made from or containing the Ti compound is a mixture of the Ti compound in another liquid diluent. In some embodiments, the diluents are hydrocarbons, optionally chlorinated, that are liquid at room temperature. In some embodiments, the liquid medium consists of the liquid titanium compound.

In some embodiments, the magnesium-based compound used as a starting compound in the first of the one or more steps (a) is selected among adducts of formula MgCl₂·nR¹OH, where n is a number between 0.1 and 6, and R¹ is a hydrocarbon radical having 1-18 carbon atoms. In some embodiments, n ranges from 1 to 5, alternatively from 1.5 to 4.5.

In some embodiments, the adduct is prepared by mixing alcohol and magnesium chloride, operating under stirring conditions at the melting temperature of the adduct (100-130 °C). Then, the adduct is mixed with an inert hydrocarbon immiscible with the adduct, thereby creating an emulsion which is quickly quenched causing the solidification of the adduct in the form of spherical particles. In some embodiments, the spherical adducts are prepared as described in U.S. Pat. Nos. 4,399,054 and 4,469,648.

In some embodiments the spherulization occurs by a spray cooling method described in U.S. Pat. Nos. 5,100,849 and 4,829,034. In some embodiments, the adducts, having a specified final alcohol content, are obtained by directly using the selected amount of alcohol during the adduct preparation.

In some embodiments, the adduct is directly reacted with the Ti compound or subjected to thermal controlled dealcoholation (80-130 °C), thereby obtaining an adduct wherein the number of moles of alcohol is lowered and the porosity increased. In some embodiments, the dealcoholation is carried out, thereby bringing the number of moles of alcohol per mole of Mg to less than 3, alternatively between 0.1 and 2.5.

In some embodiments, the reaction between the Mg-based compound and the Ti compound is carried out by suspending the Mg-based compound in large excess of cold TiCl₄. In some embodiments, the Mg-based compound is the MgCl₂-alcohol adduct. In some embodiments, the temperature of the cold TiCl₄ is 0 °C. In some embodiments, the mixture is heated up to a temperature ranging from 60-140 °C and kept at this temperature for 0.1-4 hours, alternatively 0.5-2 hours. After that time, stirring is discontinued. After the solid particles settle, the liquid phase is removed.

In some embodiments, the reaction step (a) is carried out one or more times under identical or different conditions. In some embodiments, the temperature and duration of treatment are changed. In some embodiments, the number of steps (a) is between 1 and 3.

In some embodiments, the electron donor compound is added during one or more of the reaction steps (a) between the Mg-based compound and the liquid Ti compound.

In some embodiments, the electron donor compound is added at least during the first step (a) of reaction between the Mg based compound and the Ti compound. In some embodiments, the addition of the electron donor compound is repeated one or two additional times.

In some embodiments, the electron donor compound is added as a fresh reactant to the solid intermediate catalyst component obtained by the reaction between the adduct and the Ti compound. In some embodiments, the electron donor compound is added as described in Patent Cooperation Treaty Publication No. WO2004/106388.

In some embodiments, the reaction step (a) is carried out by a continuous feeding of liquid Ti compound in an apparatus as described in Patent Cooperation Treaty Publication No. WO02/48208. In some embodiments, the liquid Ti compound is TiCl₄. In some embodiments, the Mg-based compound is fed batchwise while a continuous stream of liquid Ti compound with the specified temperature profile is fed and a liquid phase containing dissolved reaction product is continuously withdrawn. In some embodiments, the electron donor is added during the feeding of the Ti compound.

In some embodiments, the particles of solid catalyst component have substantially spherical morphology and average diameter ranging between 5 and 150 μm, alternatively from 20 to 100 μm, alternatively from 30 to 90 μm. In some embodiments, the polymerization process is carried out in gas-phase. As used herein, the term “particles having substantially spherical morphology” indicates that the particles have the ratio between the greater axis and the smaller axis equal to or lower than 1.5, alternatively lower than 1.3.

In some embodiments, the amount of Mg ranges from 8 to 30% wt, alternatively from 10 to 25% wt, with respect to the total weight of solid catalyst component.

In some embodiments, the amount of Ti ranges from 0.5 to 5% wt, alternatively from 0.7 to 3% wt, with respect to the total weight of solid catalyst component.

In some embodiments, the internal electron donor is selected from the group consisting of ethers, amines, silanes, carbamates, ketones, esters of aliphatic acids, alkyl and aryl esters of optionally substituted aromatic polycarboxylic acids, diol derivatives, or mixtures thereof. In some embodiments, the diol derivatives are selected from the group consisting of monoesters monocarbamates and monoesters monocarbonates.

In some embodiments, the alkyl and aryl esters of optionally substituted aromatic polycarboxylic acids are the esters of phthalic acids. In some embodiments, the esters of aliphatic acids are selected from the esters of malonic, glutaric, maleic and succinic acids. In some embodiments, the esters are selected from the group consisting of n-butylphthalate, di-isobutylphthalate, and di-n-octylphthalate.

In some embodiments, the internal donors are selected from the group consisting of 1,3 diethers of the formula (I):

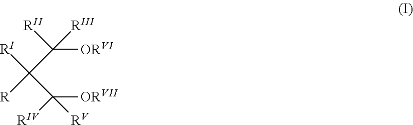

wherein R, R^{I}, R^{II}, R^{III}, R^{IV} and R^{V} are equal to or different from each other, and are hydrogen or hydrocarbon radicals having from 1 to 18 carbon atoms; and R^{VI} and R^{VII} are equal to or different from each other, and have the same meaning of R-R^{V} except that R^{VI} and R^{VII} cannot be hydrogen. In some embodiments, one or more of the R-R^{VII} groups are linked to form a cycle. In some embodiments, the 1,3-diethers have R^{VI} and R^{VII} selected from C₁-C₄ alkyl radicals.

In some embodiments, mixtures of the donors are used. In some embodiments, the mixtures are made from or containing esters of succinic acids and 1,3 diethers as described in Patent Cooperation Publication No. WO2011/061134.

It is believed that to increase the capability of the catalyst to distribute an olefin co-monomer within a polymer chain, the electron donor is selected from the group consisting of monofunctional donors. In some embodiments, the monofunctional donors are selected from the group consisting of ethers and C₁-C₄ alkyl esters of aliphatic mono carboxylic acids. In some embodiments, the resulting polymers are ethylene/α-olefin copolymers. In some embodiments, the ethers are C₂-C₂₀ aliphatic ethers, alternatively cyclic ethers. In some embodiments, the cyclic ethers have 3-5 carbon atoms. In some embodiments, the cyclic ethers are selected from the group consisting of tetrahydrofuran, methyl tetrahydrofuran, and dioxane. In some embodiments, the esters are selected from the group consisting of ethylacetate and methyl formiate. In some embodiments, the electron donor is selected from the group consisting of tetrahydrofuran and ethylacetate.

In some embodiments, the final amount of electron donor compound in the solid catalyst component ranges from 0.5 to 40 wt % by weight, alternatively from 1 to 35 wt %, with respect to the total weight of the solid catalyst component.

In some embodiments, the solid catalyst component shows a surface area (by B.E.T. method) between 20 and 500 m²/g, alternatively between 50 and 400 m²/g, and a total porosity (by B.E.T. method) greater than 0.2 cm³/g, alternatively between 0.3 and 0.6 cm³/g. In some embodiments, the porosity (Hg method) due to pores with radius up to 10.000 Å, ranges from 0.3 to 1.5 cm³/g, alternatively from 0.45 to 1.0 cm³/g.

In some embodiments, the solid catalyst component is converted into catalyst for the polymerization of olefins by reacting the solid catalyst component with alkylaluminum compounds (ii).

In some embodiments, the alkylaluminum compound (ii) is a trialkyl aluminum compound. In some embodiments, the trialkyl aluminum compound is selected from the group consisting of triethylaluminum, triisobutylaluminum, tri-n-butylaluminum, tri-n-hexylaluminum, and tri-n-octylaluminum. In some embodiments, the trialkyl aluminum compound is selected from the group consisting of alkylaluminum halides, alkylaluminum hydrides, alkylaluminum sesquichlorides, and mixtures thereof. In some embodiments, the alkylaluminum sesquichlorides are selected from the group consisting of AlEt₂Cl and Al₂Et₃Cl₃.

In some embodiments, the Al/Ti molar ratio is such that there is an excess of Al. In some embodiments, the Al/Ti molar ratio ranges between 50:1 and 2000:1, alternatively between 50:1 and 500:1.

In some embodiments, an external electron-donor compound (iii) is used. In some embodiments, the external electron-donor compound is selected from the group consisting of silicon compounds, ethers, esters, amines, heterocyclic compounds, and ketones. In some embodiments, the heterocyclic compound is 2,2,6,6-tetramethylpiperidine. In some embodiments, the external donor compounds are silicon compounds of formula (R₆)ₐ(R₇)_{b}Si(OR₈)_{c}, where a and b are integers from 0 to 2, c is an integer from 1 to 4 and the sum of (a+b+c) is 4; R₆, R₇, and R₈, are alkyl, cycloalkyl or aryl radicals with 1-18 carbon atoms optionally containing heteroatoms. In some embodiments, the external electron-donor compounds are the silicon compounds wherein a is 1, b is 1, and c is 2, at least one of R⁶ and R⁷ is selected from branched alkyl, cycloalkyl or aryl groups with 3-10 carbon atoms optionally containing heteroatoms, and R₈ is a C₁-C₁₀ alkyl group. In some embodiments, R₈ is methyl. In some embodiments, the silicon compounds are selected from the group consisting of methylcyclohexyldimethoxysilane (C donor), diphenyldimethoxysilane, methyl-t-butyldimethoxysilane, dicyclopentyldimethoxysilane (D donor), diisopropyldimethoxysilane, (2-ethylpiperidinyl) t-butyldimethoxysilane, (2-ethylpiperidinyl) thexyldimethoxysilane, (3,3,3-trifluoro-n-propyl) (2-ethylpiperidinyl)dimethoxysilane, and methyl (3,3,3-trifluoro-n-propyl)dimethoxysilane. In some embodiments, the external electron-donor compounds are the silicon compounds wherein a is 0 and c is 3, R₇ is a branched alkyl or cycloalkyl group, optionally containing heteroatoms, and R₈ is methyl. In some embodiments, the silicon compounds are selected from the group consisting of cyclohexyltrimethoxysilane, t-butyltrimethoxysilane and thexyltrimethoxysilane.

In some embodiments, the external electron donor compound is used in an amount such that the molar ratio alkylaluminum compound to the external electron donor compound is from 0.1:1 to 500:1, alternatively from 1:1 to 300:1, alternatively from 3:1 to 100:1.

In some embodiments, the molar ratio of compound (iv) to alkylaluminum compound (ii) introduced into the polymerization reactor is from 0.01 to 5, alternatively from 0.05 to 3.5, alternatively from 0.1 to 2.5.

In some embodiments, the catalyst components (i)-(iii) are contacted with a liquid inert hydrocarbon solvent at a temperature below about 60 °C, alternatively from about 0 to 30 °C, for a time period of from about six seconds to 60 minutes. In some embodiments, the liquid inert hydrocarbon solvent is propane, n-hexane or n-heptane.

In some embodiments, catalyst components (i), (ii) and optionally (iii) are fed to a pre-contacting vessel, in amounts such that the weight ratio (ii)/(i) is in the range of 0.1-10. In some embodiments, compound (iii) is present and the weight ratio (ii)/(iii) is as defined above. In some embodiments, the components are pre-contacted at a temperature of from 10 to 20 °C for 1-30 minutes. In some embodiments, the precontact vessel is a stirred tank or a loop reactor.

In some embodiments, the precontacted catalyst is then fed to the prepolymerization reactor where step (b) takes place. In some embodiments, the prepolymerization step is carried out in a first reactor selected from a loop reactor or a continuously stirred tank reactor. In some embodiments, the prepolymerization is carried out in gas-phase or in liquid-phase. In some embodiments, the prepolymerization is carried out in liquid-phase. In some embodiments, the liquid medium is made from or containing liquid alpha-olefin monomer(s), optionally with the addition of an inert hydrocarbon solvent. In some embodiments, the hydrocarbon solvent is aromatic or aliphatic. In some embodiments, the aromatic solvent is toluene. In some embodiments, the aliphatic solvent is selected from the group consisting of propane, hexane, heptane, isobutane, cyclohexane and 2,2,4-trimethylpentane. In some embodiments, the amount of hydrocarbon solvent is lower than 40% by weight, alternatively lower than 20% by weight, with respect to the total amount of alpha-olefins. In some embodiments, step (b) is carried out in the absence of inert hydrocarbon solvents.

In some embodiments, the average residence time in this reactor ranges from 2 to 40 minutes, alternatively from 10 to 25 minutes. In some embodiments, the temperature is between 10 °C and 50 °C, alternatively between 20 °C and 40 °C. In some embodiments, these conditions yield a pre-polymerization degree ranging from 60 to 800 g, alternatively from 150 to 500 g, per gram of solid catalyst component. In some embodiments, the prepolymerization step yields a low concentration of solid in the slurry, alternatively a concentration of solid in the range from 50 g to 300 g of solid per liter of slurry.

In some embodiments, the process is carried out in a polymerization plant including a liquid-phase polymerization reactor, a gas-phase polymerization reactor, or both. In some embodiments, the liquid-phase reactors are selected from the group consisting of loop reactors and continuously stirred tank reactors (CSTR). In some embodiments, the gas-phase reactors are selected from the group consisting of fluidized bed reactors, stirred bed reactors and reactors having two interconnected polymerization zones as described in European Patent Application Nos. EP 0782587 and EP 1012195. In some embodiments, the process is carried out in two or more cascade reactors, giving rise to a sequential multistage polymerization process. In some embodiments, a fluidized bed reactor is used to prepare a first polymer component, which is successively fed to a gas-phase reactor, having two interconnected polymerization zones, to prepare a second polymer component and a third polymer component. In some embodiments, a first fluidized bed reactor is used to prepare a first polymer component, which is successively fed to a second fluidized bed reactor to prepare a second polymer component and then to a third fluidized bed reactor to prepare a third polymer component. In some embodiments, an olefin polymer with a multi-modal molecular weight distribution is obtained. In some embodiments, an olefin copolymer made from or containing two or more components, having a different comonomer content, is prepared.

In some embodiments, the polymerization process is carried out as gas-phase polymerization, that is, by a process in which the solid polymers are obtained from a gas-phase of the monomer or the monomers. In some embodiments, the gas-phase polymerizations are carried out at pressures of from 0.1 to 20 MPa, alternatively from 0.5 to 10 MPa, alternatively from 1.0 to 5 MPa, and polymerization temperatures from 40 to 150 °C, alternatively from 65 to 125 °C.

In some embodiments, gas-phase polymerization reactors are selected from the group consisting of horizontally or vertically stirred reactors, fluidized bed gas-phase reactors, and multizone circulating reactors.

Fluidized-bed polymerization reactors are reactors in which the polymerization takes place in a bed of polymer particles, which is maintained in a fluidized state by feeding in gas at the lower end of a reactor and taking off the gas again at the reactor's upper end. In some embodiments, the gas is fed below a gas distribution grid, having the function of dispensing the gas flow. The reactor gas is then returned to the lower end of the reactor via a recycle line equipped with a compressor and a heat exchanger. In some embodiments, the circulated reactor gas is a mixture of the olefins to be polymerized, inert gases, and optionally a molecular weight regulator. In some embodiments, the inert gases are selected from the group consisting of nitrogen, lower alkanes, or both. In some embodiments, the lower alkanes are selected from the group consisting of ethane, propane, butane, pentane, and hexane. In some embodiments, the molecular weight regulator is hydrogen. In some embodiments, nitrogen or propane is used as inert gas, alternatively in combination with further lower alkanes. In some embodiments, the velocity of the reactor gas fluidizes the mixed bed of finely divided polymer present in the tube serving as polymerization zone and removes the heat of polymerization. In some embodiments, the polymerization is carried out in a condensed or super-condensed mode, wherein part of the circulating reaction gas is cooled to below the dew point and returned to the reactor separately as a liquid and a gas-phase or together as a two-phase mixture, thereby using the enthalpy of vaporization for cooling the reaction gas.

Multizone circulating reactors are gas-phase reactors in which two polymerization zones are linked to one another and the polymer is passed alternately a plurality of times through these two zones. In some embodiments, the reactors are as described in Patent Cooperation Treaty Publication Nos. WO 97/04015 A1 and WO 00/02929 A1 and have two interconnected polymerization zones, a riser, in which the growing polymer particles flow upward under fast fluidization or transport conditions and a downcomer, in which the growing polymer particles flow in a densified form under the action of gravity. The polymer particles, leaving the riser, enter the downcomer, and the polymer particles, leaving the downcomer, are reintroduced into the riser, thereby establishing a circulation of polymer between the two polymerization zones. The polymer is passed alternately a plurality of times through these two zones. In some embodiments, the two polymerization zones of one multizone circulating reactor are operated with different polymerization conditions by establishing different polymerization conditions in the riser and the downcomer. In some embodiments, the gas mixture, leaving the riser and entraining the polymer particles, is partially or totally prevented from entering the downcomer. In some embodiments, a barrier fluid is fed in form of a gas, a liquid mixture, or both into the downcomer, in the upper part thereof. In some embodiments, the barrier fluid has a composition different from the composition of the gas mixture present in the riser. In some embodiments, the amount of added barrier fluid is adjusted such that an upward flow of gas countercurrent to the flow of the polymer particles is generated, thereby acting as a barrier to the gas mixture entrained among the particles coming from the riser. In some embodiments, the countercurrent occurs at the top thereof. In some embodiments, two different gas composition zones occur in a multizone circulating reactor. In some embodiments, make-up monomers, comonomers, molecular weight regulator, inert fluids, or a combination thereof is introduced at any point of the downcomer, below the barrier feeding point. In some embodiments, the molecular weight regulator is hydrogen. In some embodiments, varying monomer, comonomer and hydrogen concentrations along the downcomer are used to differentiate the polymerization conditions.

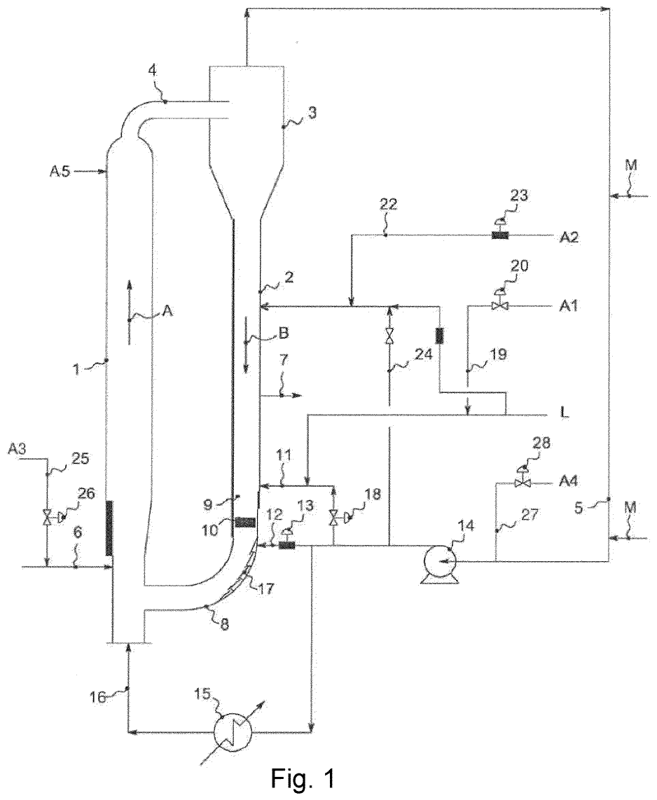

With reference to FIG. 1, a gas phase polymerization reactor having two interconnected polymerization zones (riser and downcomer) is shown.

In some embodiments, the polymerization reactor includes a first polymerization zone 1 (riser), wherein the polymer particles flow upward under fast fluidization conditions along the direction of the arrow A and a second polymerization zone 2 (downcomer), wherein the polymer particles flow downward under the action of gravity along the direction of the arrow B.

The upper portion of the riser 1 is connected to a solid/gas separator 3 by an interconnection section 4. The separator 3 removes a major part of the unreacted monomers from the polymer particles. The polymer, withdrawn from the bottom of separator 3, enters the top portion of the downcomer 2. The separated unreacted monomers, optionally together with polymerization diluents, flow up to the top of separator 3 and are successively recycled to the bottom of the riser 1 via a recycle line 5. In some embodiments, the diluent is propane.

In some embodiments, a mixture made from or containing one or more olefin monomers, hydrogen as a molecular weight regulator, propane as a polymerization diluent, is fed to the polymerization reactor via one or more lines M, which are placed along the gas recycle line 5.

In some embodiments, the catalyst components, optionally after a prepolymerization step, are continuously introduced into the riser 1 via line 6. In some embodiments, the produced polymer is discharged from the reactor via a line 7. In some embodiments, line 7 is placed on the lower portion of the downcomer 2, thereby and due to the packed flow of densified polymer, minimizing the quantity of gas entrained with the discharged polymer. In some embodiments and not shown herein, a control valve is inserted on the polymer discharge line 7, thereby providing for continuous control of the flow rate of polymer produced by the polymerization reactor. In some embodiments, additional polymer discharge lines with respect to line 7 are placed in the bottom part of the downcomer.

In some embodiments, the polymerization reactor further includes a transport section 8 connecting the bottom of downcomer 2 with the lower region of the riser 1. In some embodiments, the bottom of the downcomer 2 converges into a slight restriction 9. In some embodiments, a control valve 10 with an adjustable opening is placed within the restriction 9. In some embodiments, the flow rate Fp of polymer continuously circulated between the downcomer 2 and the riser 1 is adjusted by the level of opening of the control valve 10. In some embodiments, the control valve 10 is a mechanical valve. In some embodiments, the mechanical value is selected from the group consisting of a butterfly valve and a ball valve. In some embodiments, a stream of dosing gas is fed into the lower part of the downcomer 2 by a line 11 placed at a short distance above the restriction 9. In some embodiments, the dosing gas to be introduced through line 11 is taken from the recycle line 5. In some embodiments, the flow Fp of polymer particles circulated between downcomer 2 and riser 1 is adjusted by varying the opening of the control valve 10 at the bottom of the downcomer, by varying the flow rate of the dosing gas entering the downcomer via line 11, or both. In some embodiments, the flow rate of dosing gas is adjusted by a control valve 18, which is arranged on line 11.

The transport section 8 is designed as a bend descending from the bottom of downcomer 2 up to the lower region of the riser 1. In some embodiments, a carrier gas is introduced via line 12 at the inlet of the transport section 8. In some embodiments, the flow rate of carrier gas is adjusted by a control valve 13, which is arranged on line 12.

In some embodiments, the carrier gas is taken from the gas recycle line 5. In some embodiments, the gas recycle stream of line 5 is first subjected to compression by a compressor 14. A minor percentage of the recycle stream passes through line 12, thereby entering the transport section 8 and diluting the solid phase of polymer flowing through the transport section 8. The major part of the recycle stream, downstream the compressor 14, is subjected to cooling in a heat exchanger 15 and successively introduced via line 16 at the bottom of the riser 1 at a high velocity, thereby ensuring fast fluidization conditions in the polymer bed flowing along the riser 1.

In some embodiments, the carrier gas merges with the densified polymer coming from downcomer 2 at the inlet portion of transport section 8, after exiting the slits of the gas distribution grid 17. In some embodiments, the top end of the distribution grid 17 coincides with the inlet of the transport section 8. In some embodiments, the distribution grid 17 extends along the bending of the transport section 8 for an angle α=60°. The gas distribution grid 17 is formed by a plurality of trays fixed to the transport section 8 which form slits in the overlapping area of adjacent trays. In some embodiments, the gas distribution grid 17 is as described in Patent Cooperation Treaty Publication No. WO 2012/031986.

In some embodiments, a flow rate of compound (iv) is metered into the reactor at the bottom of the riser, at a point in the riser 1, or both. In some embodiments, a flow rate of compound (iv) is metered into the reactor at the top of the riser (flow rate A5).

In some embodiments, an additional feeding point is at flow rate A3, via line 25 and metered by valve 26 into catalyst feed line 6. In some embodiments, an additional feeding point is into the main gas recycle line 5 (flow rate A4, line 27 metered by valve 28).

In some embodiments, the compound (iv) is alternatively or additionally metered to positions along the height of the downcomer via nozzles as described in Patent Cooperation Treaty Publication No. WO 2011/029735. In some embodiments, the compound (iv) flow rate A2 in line 22 is metered by one or more valves 23 and then pre-dispersed in the liquid monomer L or in a fraction of recycle gas taken from recycle line 5 via line 24.

In some embodiment and depending on the olefin homopolymer or copolymer to be produced, the polymerization reactor is operated by adjusting the polymerization conditions and the monomers concentration in the riser and in the downcomer. In some embodiments, the process produces a wide variety of bimodal homopolymers and random copolymers. In some embodiments, the gas mixture entraining the polymer particles and coming from the riser is partially or totally prevented from entering the downcomer, thereby polymerizing two different monomers compositions in the riser and the downcomer. In some embodiments, a gaseous barrier stream, a liquid barrier stream, or both are fed through a line placed in the upper portion of the downcomer. In some embodiments, the barrier stream has a composition different from the gas composition present inside the riser. In some embodiments, the flow rate of the barrier stream is adjusted, thereby generating an upward flow of gas counter-current to the flow of the polymer particles and acting as a barrier to the gas mixture coming from the riser. In some embodiments, the counter-current is at the top of the downcomer. In some embodiments, the barrier effect at the top of the downcomer occurs as described in European Patent Application No. EP 1012195 A1.

In some embodiments, different or identical polymerization processes are connected in series, thereby forming a polymerization cascade. In some embodiments, a parallel arrangement of reactors of two or more different or identical processes is used.

In some embodiments, the gas-phase polymerization processes are carried out in the presence of an alkane having from 3 to 5 carbon atoms as a polymerization diluent. In some embodiments, the diluent is propane.

In some embodiments, the process is used in a multizone circulating reactor for producing polymer particles having a MFR_{2.16} at a temperature of 190 °C under a load of 2.16 kg of less than 60 g/10 min.

In some embodiments, the process is a cascade process including two or more fluidized-bed gas-phase reactors. In some embodiments, the compound (iv) is added into the bed of each reactor, to the polymer discharge downstream each reactor, before the first reactor, or a combination thereof.

### EXAMPLES

The following examples are given to be illustrative without limiting the scope of this disclosure in any manner whatsoever.

### Test Methods

### Melt Flow Rate (MFR “L”)

Determined according to ISO 1133 (230 °C, 2.16 Kg).

### Ethylene Content in Copolymers

### 13C NMR of Propylene/Ethylene Copolymers

13C NMR spectra were acquired on a Bruker AV-600 spectrometer equipped with cryoprobe, operating at 160.91 MHz in the Fourier transform mode at 120 °C.

The peak of the Sββ carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as an internal standard at 29.9 ppm. The samples were dissolved in 1,1,2,2-tetrachloroethane-d2 at 120 °C with an 8% wt/v concentration. Each spectrum was acquired with a 90° pulse, 15 seconds of delay between pulses and CPD, thereby removing 1H-13C coupling. 512 transients were stored in 32K data points, using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with 8-titanium trichloride-diethylaluminum chloride” M. Kakugo, Y. Naito, K. Mizunuma and T. Miyatake, Macromolecules 1982, 15, 4, 1150-1152) using the following equations:

PPP=100Tββ/S PPE=100Tβδ/S EPE=100Tδδ/S

PEP=100Sββ/S PEE=100Sβδ/S EEE=100(0.25Sγδ+0.5Sδδ)/S

S=Tββ+Tβδ+Tδδ+Sββ+Sβδ+0.25Sγδ+0.5Sδδ

The molar percentage of ethylene content was evaluated using the following equation:

E % mol=100*[PEP+PEE+EEE]

The weight percentage of ethylene content was evaluated using the following equation:

$$E \% wt . = \frac{100 * E \% mol * {MW}_{E}}{E \% mol * {MW}_{E} + P \% mol * {MW}_{P}}$$

where P % mol is the molar percentage of propylene content, while MW_{E} and MW_{P} are the molecular weights of ethylene and propylene, respectively.

### Xylene Solubles (XS)

Determined as follows: 2.5 g of polymer and 250 ml of xylene were introduced in a glass flask equipped with a refrigerator and a magnetic stirrer. The temperature was raised in 30 minutes up to the boiling point of the solvent. The solution was then kept under reflux and stirring for further 30 minutes. The closed flask was then kept in thermostatic water bath at 25 °C for 30 minutes. The formed solid was filtered on quick filtering paper. 100 ml of the filtered liquid was poured in a pre-weighed aluminum container, which was heated on a heating plate under nitrogen flow, thereby removing the solvent by evaporation. The container was then kept in an oven at 80 °C under vacuum until constant weight was obtained. The weight percentage of polymer soluble in xylene at room temperature was then calculated.

### Melting Point and Crystallization Point

The melting point was measured using a Differential Scanning Calorimetry (DSC) instrument according to ISO 11357-3, at scanning rate of 20 °C/min, both in cooling and heating, on a sample of weight between 5 and 7 mg., under inert N₂ flow. Instrument calibration was made with Indium.

### EXAMPLES

### Comparative Example 1-2 and Inventive Examples 3-4

A 4-liter steel autoclave equipped with a stirrer, pressure gauge, thermometer, catalyst feeding system, monomer feeding lines and thermostatic jacket, was purged with nitrogen flow at 70 °C for one hour. At 30 °C and under propylene flow, 0.1 g of PPA dissolved in hexane, 75 ml of anhydrous hexane containing 0.25 g of AlEt₃, about 10 mg of solid catalyst component prepared according to example 5 of European Patent Application No. EP728769, and an amount of cyclohexylmethyl dimethoxysilane, as the external donor, thereby providing an Aluminum/donor molar ratio of 10, were charged to the autoclave. The autoclave was closed. Subsequently, 1.25 NL of hydrogen were added. Then, under stirring, 1.2 kg of liquid propylene were fed. The temperature was raised to 70 °C in ten minutes. The polymerization was carried out at this temperature for two hours. At the end of the polymerization, the non-reacted propylene was removed. The polymer was recovered and dried in an oven at 80 °C. Results are reported in Table 1.

TABLE 1

| | | | | | | Poured |
|---|---|---|---|---|---|---|
| | | | Residual | | Melt | bulk |
| | PPA | Mileage | Mileage | XI | Index-L | density |
| Example | g | Kg(PP)/g(cat) | % | % wt | g/10′ | g/mL |
| C1 | 0 | 42 | 100 | 97.5 | 2.0 | 0.454 |
| C2 | 0.1 | 34 | 81 | 97.4 | 1.6 | 0.444 |
| 3 | 0.1 | 36 | 86 | 97.6 | 1.6 | 0.448 |
| 4 | 0.1 | 35 | 83 | 97.7 | 1.4 | 0.449 |

C2 PPA = Glycerol monostearate
Ex. 3 PPA = 40% wt mono and 60% wt diglycerol esters of octanoic and decanoic acid
EX. 4 PPA = Glycerol monocaprylate

### Example 5

The polymerization was carried out in continuous by a process setup including:
1.5-liter vessel for the pre-contact of the catalyst components;
a loop prepolymerization reactor, having a volume of 80 liters; and
a sequence of two serially connected fluidized bed reactors, each having a volume of 1.5 m³.

### Precontact

A Ziegler-Natta catalyst system was used as the polymerization catalyst, comprising:
a solid catalyst component prepared according to example C1 of WO2012/139897;
triethylaluminium (TEAL) as the cocatalyst;
dicyclopentyldimethoxysilane (DCPMS) as the external donor.

The solid catalyst components were fed to the pre-contacting vessel. The weight ratio TEAL/solid catalyst was 4. The weight ratio TEAL/DCPMS was 5.

The components were pre-contacted at a temperature of 12 °C for 10 minutes.

### Pre-Polymerization

The catalyst system, withdrawn from the pre-contacting vessel, was continuously fed to the prepolymerization loop reactor together with a liquid stream of propylene and propane. The pre-polymerization occurred at a temperature of 20 °C.

### Polymerization

A polypropylene slurry was continuously discharged from the loop reactor and fed to the first fluidized bed reactor, where propylene was polymerized using H₂, as the molecular weight regulator, in the presence of propane as inert diluent. The polymerization was carried out according to the conditions reported in Table 1. The polymer discharged from the first reactor was then conveyed to the second reactor, where the ethylene/propylene copolymerization was carried out.

The PPA was a mixture of commercially available 40% wt mono and 60% wt diglycerol esters of octanoic and decanoic acid diluted in hexane. The PPA was fed via propylene carrier, partly to the first and second gas-phase reactors via fluidization gas and partly to the polymer discharged from the first reactor before being introduced into the second. The flow rate of the PPA feed resulted the amounts of PPA in the polymer, indicated in Table 2.

### Comparative Example 6

Using the same reactor set-up and conditions of Example 5, the same type of product was prepared with the difference being that molten glycerol monostearate was used as PPA.

The PPA of example 5 controlled the reactivity of fine particles, that is, particles having a particle size less than 500 μm, and lowered the C2 ratio, with respect to PPA used in C6.

TABLE 2

| | Example | | | |
|---|---|---|---|---|
| | 5 | | Comparative 6 | |
| | GP1 | GP2 | GP1 | GP2 |
| Temperature (°C) | 70 | 60 | 70 | 60 |
| Pressure (barg) | 16 | 18 | 18 | 19 |
| Split (%) | 31 | 69 | 32 | 68 |
| C₂⁻/C₂⁻ + C₃⁻ (mol/mol) | 0.018 | 0.142 | 0.021 | 0.147 |
| H₂/C₂⁻ (mol/mol) | | 0.071 | | 0.074 |
| H₂/C3⁻ (mol/mol) | 0.072 | | 0.076 | |
| Mileage (kg/g) | 11.1 | | 11.4 | |
| Compound (iv) ppm/production | 320 | 290 | 440 | 447 |

| | | |
|---|---|---|
| MFR “L” (dg/min) | 19.3 | 19.5 |
| Ethylene content (wt %) copo | 26.4 | 27.0 |
| Xylene solubles (wt %) | 64.7 | 63.9 |
| Ethylene content on fines (wt %) | 8.7 | 12.9 |
| C2 ratio (C2 fines/C2 copo) | 45% | 66% |

What is claimed is:

1. A process for the polymerization of olefins, carried out in the presence of (i) a Ziegler-Natta catalyst, (ii) an aluminum alkyl cocatalyst, optionally (iii) an external donor, and (iv) at least 50 ppm of a compound comprising mono or diglycerol ester derivatives of saturated C₆-C₁₂ monocarboxylic acids, based on the amount of polyolefin produced.

2. The process according to claim 1, wherein the process is carried out in gas-phase.

3. The process according to claim 1, wherein the solid catalyst component (i) contains an internal donor.

4. The process according to claim 3, wherein the internal donor is selected from the group consisting of ethers, amines, silanes, carbamates, ketones, esters of aliphatic acids, alkyl and aryl esters of optionally substituted aromatic polycarboxylic acids, diol derivatives, or mixtures thereof.

5. The process according to claim 1, wherein external electron-donor compound (iii) is present and selected from silicon compounds of formula (R₆)ₐ(R₇)_{b}Si(OR₈)_{c}, where a and b are integers from 0 to 2, c is an integer from 1 to 4 and the sum of (a+b+c) is 4; R₆, R₇, and R₈, are alkyl, cycloalkyl or aryl radicals with 1-18 carbon atoms optionally containing heteroatoms.

6. The process according to claim 1, wherein the compound (iv) comprises (a) more than 50% wt of mono or diglycerol ester derivatives of saturated C₆-C₁₀ monocarboxylic acids, and (b) mono or polyglycerol fatty acid esters, with respect to the total amount of mono or polyglycerol fatty acid esters.

7. The process according to claim 1, wherein the compound (iv) comprises one or more of mono or diglycerol ester derivatives of saturated C₆-C₁₀ monocarboxylic acids and mixtures thereof.

8. The process according to claim 1, wherein compound (iv) comprises (a) more than 50% wt of mono or diglycerol ester derivatives of saturated C₆-C₁₀ monocarboxylic acids selected from the group consisting of glycerol monoester or diester of octanoic acid, glycerol monoester or diester of decanoic acid, glycerol diester mixed octanoic and decanoic acid, diglycerol mono, di- or triester of octanoic acid, diglycerol mono, di- or triester of decanoic acid, diglycerol di or triester of mixed octanoic and decanoic acid and mixtures thereof, and (b) mono or polyglycerol fatty acid esters, based on the total amount of fatty acid mono or polyglycerol esters.

9. The process according to claim 8, wherein the mono or diglycerol ester derivatives of saturated C₆-C₁₀ monocarboxylic acids are selected from the group consisting of glycerol mono octanoate; mixtures comprising glycerol diester of octanoic acid, glycerol diester of mixed octanoic and decanoic acid; and diglycerol mono ester of octanoic acid, diglycerol mono ester of decanoic acid and mixtures thereof.

10. The process according to claim 1, wherein compound (iv) is introduced into the polymerization reactor in an amount ranging from 70 to 2000 ppm per weight, referring to the weight of the prepared polyolefin.

11. The process according to claim 1, wherein compound (iv) is fed to the polymerization reactor in a flow of saturated or unsaturated hydrocarbon, having from 2 to 6 carbon atoms.

12. The process according to claim 1, wherein the molar ratio of compound (iv) to alkylaluminum compound (ii) introduced into the polymerization reactor is from 0.01 to 5.

13. The process according to claim 1, wherein compound (iv) is fed directly into the reactor, into a line leading to the reactor, into a line exiting the reactor, or a combination thereof.

14. The process according to claim 1, wherein compound (iv) is fed upstream the polymerization reactor.

15. The process according to claim 2, wherein the gas-phase reactor is fluidized bed reactor, a multizone circulating reactor, or both.
